(19) United States
(12) Patent Application Publication
(10) Pub. No.: US 2016/0009577 A1
(43) Pub. Date: Jan. 14, 2016

(54) Water Purification Device

(71) Applicant: WORLDWIDE PIPING PRODUCTS (M) SDN BHD, KUALA LAMPUR (MY)

(72) Inventor: ROBERT SINCLAIR, KUALA LAMPUR (MY)

(73) Assignee: WORLDWIDE PIPING PRODUCTS (M) SDN BHD, KUALA LAMPUR (MY)

(21) Appl. No.: 14/545,983

(22) Filed: Jan. 16, 2014

(30) Foreign Application Priority Data
Apr. 30, 2013 (MY) PI2013700699
Aug. 27, 2013 (MY) PCT/MY2013/000149

(51) Int. Cl. C02F 1/78; C02F 1/32

(52) U.S. Cl. CPC C02F 1/78; C02F 1/325; C02F 2201/32

(57) ABSTRACT

A water purification device which can process contaminated water, and upgrade it to a potable quality or other secondary useful purposes such as irrigation, shower or laundry and general water. This is achieved without the use of chemicals or membranes. The device consists of a geometrical configuration of riser and connecting tubes for contacting ozone and ultraviolet (UV) light with said contaminated water in order to provide an advance oxidation environment, resulting in disinfection, a reduction in biological activity, chemical oxygen demand, organic species and other water-borne contaminants such as fungi, molds algae, bacteria, viruses, protozoa, oils, fats, tastes and odours. The geometrical configuration of contacting the ozone, UV and water, combined with an ozone injection system that results in optimum disinfection of the water.

This invention was made with the support of Worldwide Water Technologies Sdn Bhd, and as such Worldwide Piping Products (M) Sdn Bhd has the rights to this invention.

### FIELD OF THE INVENTION

This invention relates to medium scale (1 m³ per day to greater than 500 m³ per day) water purification devices, their method of making and their method of use.

### BACKGROUND OF THE INVENTION

Upgrading water, which has chemical or biological contaminants; to a degree such that it can be useful, is a major challenge in many areas of the world. Currently, water purification systems are mostly large-scale, such as municipal sewage treatments works (STW) or reverse osmosis (RO) plants. Both provide a quality of water which is fit for purpose, but both have significant environmental negatives. STW plants require the chemical addition of substances such as chlorine and iron sulphate, both of which have a financial and an environmental cost. As for RO there are the significant financial and environmental costs of the RO membranes, which clog and need frequent replacing. In addition to this, the RO process produces two streams: one being of water of the required quality, and the other being of water which is of an even higher level of contamination than the original contaminated water. This more contaminated stream, which generally contains high levels of salts, most frequently sodium chloride, is a common environmental problem as the more contaminated stream requires disposal in the environment. The result of this disposal often has a deleterious effect on local wildlife and ecology generally. Additionally, when an old RO membranes need to be removed, usually due to its pores being clogged, or otherwise damaged, the membrane needs to be disposed of. As membranes are typically made from non-biodegradable materials, as well as being clogged with contaminants, the disposal of these used membranes represents an additional challenge in terms of ecologically-friendly disposal.

By using this system, which is based on the use of ozone and UV in synergistic combination, provides an efficient method of disinfection of contaminated water, and the above negatives of STW and RO are avoided. This is because the invention uses no chemical additives whatsoever and no membranes either.

On a smaller scale, filter-based systems are commonly used for purification of water. These typically use a porous medium to trap, and hence remove contaminants from water or are membrane-based denominated micro or ultra-filters. As with STW and RO systems, although filters do produce a quality of water that is fit for purpose, they have the drawback of requiring a filter medium. Typically the filter medium is a porous ceramic, activated carbon, or polymer based material. As with RO systems, the filtering medium requires frequent replacement and chemical cleaning, and so there are financial and environmental costs of manufacturing and operating the filter medium. Additionally, the problems of the ecologically-friendly disposal of the filter medium after it has come to the end of its useful life are considerable.

The invention provides the upgrading of water in a range of critical areas for reuse or drinking, with a particular emphasis on:
chemical oxygen demand (COD) reduction
biological oxygen demand (BOD) reduction
pathogen and bacteria reduction, including legionella, E-coli, pseudomonas and Bacilli
parasite elimination, including Cryptosporidium, Giardia, amoebae, protozoa
fat and oil reduction, or elimination
taste and odour remediation

All of which are of major concern for users of water in a wide range of applications.

### BRIEF DESCRIPTION OF THE INVENTION

Accordingly, the above disadvantages of prior art are overcome by the present invention which provides a water purification apparatus comprising a horizontal pipe inlet, to a series of riser tubes which contain UV lamps and act as risers for the counter-current contacting of contaminated water with ozone gas and UV light. The riser tubes are connected by tubes inclined at an off-vertical acute (less than 80 degrees) angle. Ozone gas is introduced at or near the base of the riser tubes via a delivery system.

The ozone is made by an ozone generator utilizing corona discharge or UV technology, which takes as its input ambient air, and is sited separately from the main reactor tubes.

After passing through the last of the series of riser tubes, the now upgraded water passes through a riser tube for discharge into a secondary reaction vessel where the water, still containing dissolved and the remains of unreacted ozone has a sufficient residence time to allow tertiary treatment and stabilization.

The invention is designed to be portable for use in trucks, trailers or moveable containers as well as being suitable for permanent installation.

### BRIEF DESCRIPTION OF THE DRAWINGS

FIG. 1 is a cross section view of the water purification system, constructed according to the teachings of the present invention. In this illustration, the illustration is show in its abbreviated form, with just the first and the last riser tubes. This invention covers the use of more than two riser tubes, as a larger number of tubes give a higher degree of water cleaning.

FIG. 2 is a cross section view of a UV lamp and sheath assembly. The assembly comprises an electrical UV lamp inserted into a cylindrical sheath which is sealed so as to prevent direct contact of the UV lamp with the contaminated water.

FIG. 3 is a plan view of a typical UV lamp and sheath support which is shown for a six (6) lamp assembly but may be for any number of lamps for use in this invention between one (1) and sixteen (16) per riser tube. This assembly is attached to the wall of the riser tube by permanent or removable fixtures.

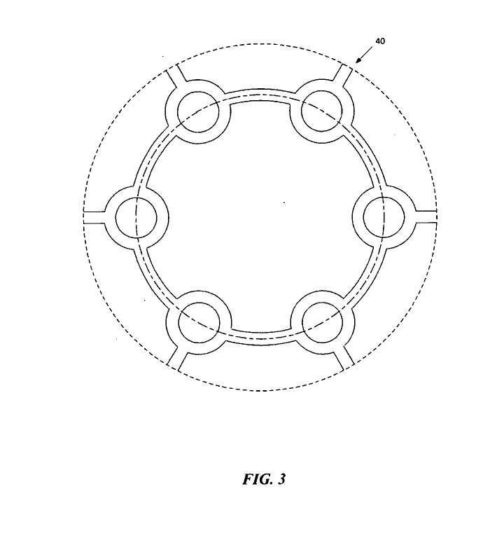

FIG. 4 is a cross-section view of the ozone delivery device which allows the ozone gas to come into direct contact with the water to be treated.

### REFERENCE NUMERALS

10 horizontal inlet pipe
12 UV lamp insert assembly
14 connecting flange
16 riser tube
18 ozone gas input
20 off-vertical connecting pipe
22 horizontal foam collection pipe
24 foam output point
26 water outlet
28 secondary reaction chamber
30 final output point
32 UV lamp fitting
34 transparent sheath
36 collar fitting
38 UV lamp
40 UV lamp sheath support
42 water inlet
44 throat
46 connector
48 diffuser tube
50 orifice

### DETAILED DESCRIPTION OF THE INVENTION

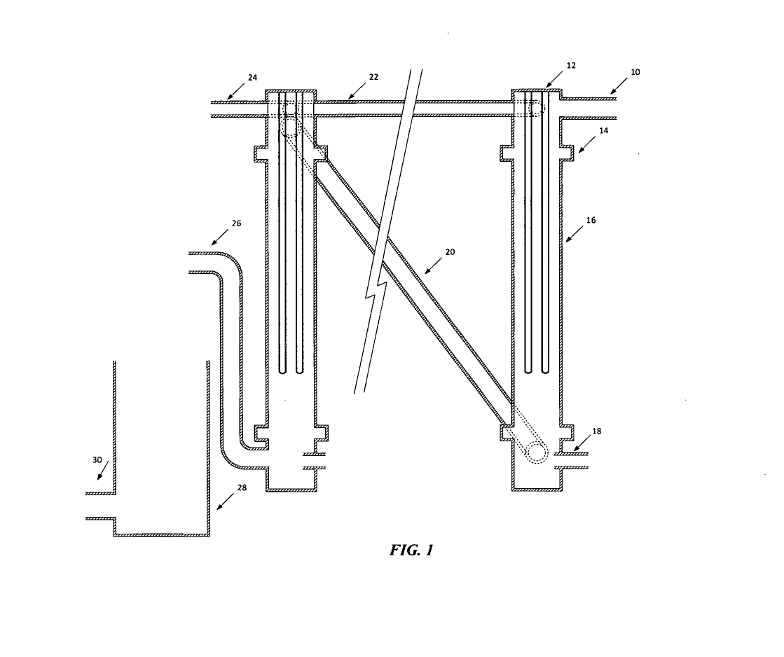

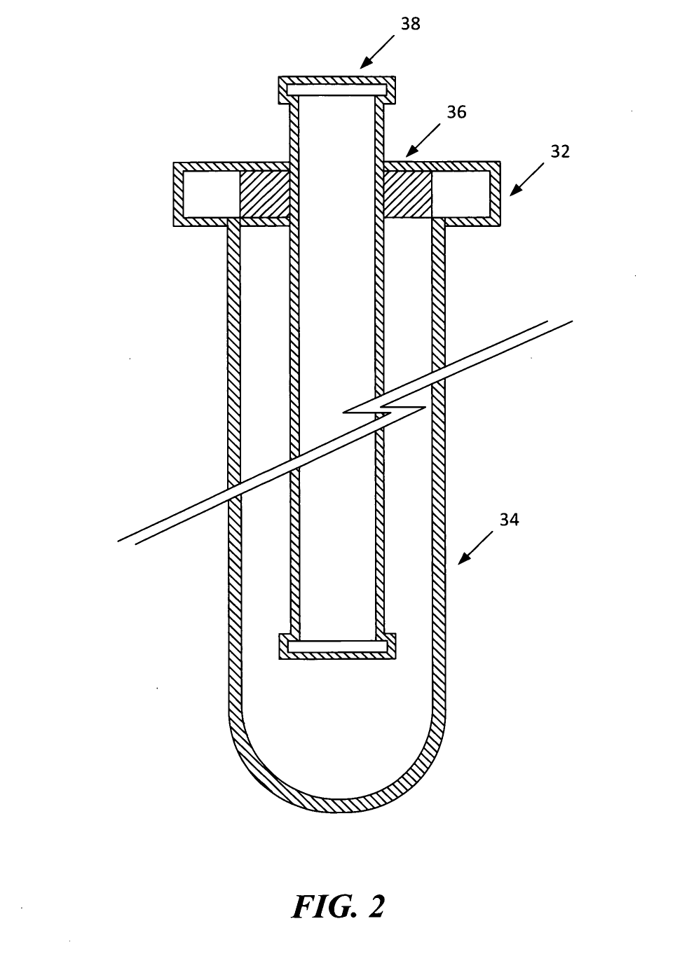

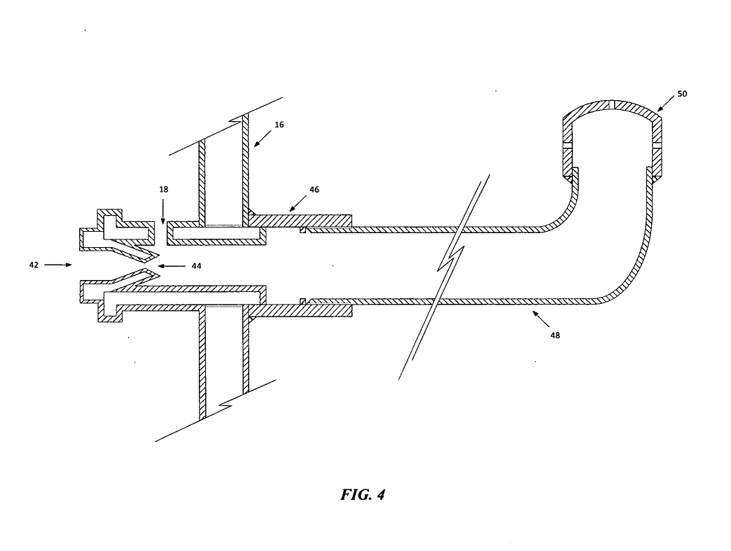

As best shown in FIGS. 1 and 2, a water purification device according to a present embodiment of the present invention comprises a series of two or more reaction tubes. In these reaction tubes, contaminated water enters inlet pipe 10 under ambient temperature and pressure, and passes downward through tube 16 under the action of gravity. In tube 16 the contaminated water comes in contact, counter-currently with ozone gas which is introduced into the tube 16 from the injection point 18 using either an ozone delivery device (FIG. 4) or a perforated tube. For a perforated tube at injection point 18 can be either a circular or spiral tube with perforations of less than 3 mm in diameter.

Initial disinfection of contaminated water is effected by (a) the counter-current contacting of the water with ozone, with the ozone gas moving up due to its lower density, and the water flowing down under the action of gravity, and (b) disinfection resulting from the irradiation of contaminated water by the action of the UV light.

The quantity of ozone gas used in the invention shall be in the range 4 to 1000 g of ozone per cubic metre of water treated.

In tube 16 contaminated water is exposed to UV light from a number of sheathed UV light sources 12 which disinfects the water under the action of UV radiation in the wavelength range 170 nanometers to 255 nanometers. The UV lamps are contained within the sheaths (FIG. 2) and are suspended vertically from the top of the tube 16. The sheaths 34 are located by a fixed or removable collar fitting 36, which are in turn located by the UV lamp sheath support 40.

The reaction tubes are connected with off-vertical connecting tubes, in which contaminated water flows upwards.

The number of reaction tubes is subject to the cleaning duty of the device, with that number typically being in the range two to twelve, being arranged in series or in multiple parallel banks.

After the contaminated water has passed through the last of the riser tubes 16, it enters outlet pipe 26 and then goes on to enter secondary reaction chamber 28. Under normal operation, the treated water leaves secondary reaction chamber 28 by outlet pipe 30 under the action of gravity. However the invention also includes the option of using an activated carbon filter, or other equivalent porous medium for the purposes of additional water quality upgrading.

The materials of the vertical riser tubes 16, connecting pipes 20 and ancillary fittings are steel, other metal or suitable non-metal materials.

FIG. 2 shows the sheathed UV lamp insert. The UV lamp 38 is powered by an external electrical source, and secured in the sheath with a collar fitting 36. The material of the sheath 34 is quartz glass, or an equivalent material transparent to UV light in said wavelength range.

We claim:

1. A water purification device, comprising
a. an inlet for contaminated water
b. a series of riser tubes for counter-current contacting of ozone gas and contaminated water
c. the introduction of ozone gas at the base of the riser tubes of b. such that the ozone gas comes in direct contact with the contaminated water, and that the method of introduction of the ozone is by direct injection, vacuum-induced injection, or a positive pressure relative the pressure at the point of injection in the tube
d. within the riser tubes are a series of UV lamps
e. each UV lamp is sheathed in a quartz, or similar material,
f. a series of off vertical tubes as risers for further contacting of ozone gas and contaminated water
g. a horizontal off-take tube to enable removal of solids from contaminated water that result from froth-flotation
h. a secondary reaction vessel to allow unreacted ozone, which may be still dissolved in the treated water, sufficient time to permit additional cleaning of water via disinfection reactions.

2. A water purification device which reduces the BOD, COD and pathogen content of contaminated water, thereby upgrading its quality for potable uses or other standards for reuse.

3. The apparatus of claim 2, comprises a geometrical configuration which gives a high degree of gas-liquid contact thereby producing a high degree of water upgrading.

4. The apparatus of claim 2, includes, as a final processing stage, a secondary reaction vessel such that any remaining unreacted ozone has a sufficient residence time to disinfect further any remaining contaminated water
